(19) United States
(12) Patent Application Publication
(10) Pub. No.: US 2026/0040068 A1
(43) Pub. Date: Feb. 5, 2026

(54) METHOD AND DEVICE FOR PROVIDING MIRRORING SERVICE BASED ON WI-FI COMMUNICATION

(71) Applicant: Samsung Electronics Co., Ltd., Suwon-si (KR)

(72) Inventors: Hyunseob OH, Suwon-si (KR); Junha PARK, Suwon-si (KR); Kisoo AN, Suwon-si (KR); Sehee HAN, Suwon-si (KR)

(21) Appl. No.: 19/283,942

(22) Filed: Jul. 29, 2025

(30) Foreign Application Priority Data
Jul. 30, 2024 (KR) 10-2024-0101096

(51) Int. Cl. H04W 12/06; H04L 67/55; H04N 21/4363; H04W 48/16

(52) U.S. Cl. CPC H04W 12/06; H04L 67/55; H04N 21/43637; H04W 48/16

(57) ABSTRACT

A method of a first electronic device in a wireless communication system is provided. The method includes triggering a wireless fidelity aware (Wi-Fi Aware) interface, transmitting a first message including miracast-related information through Wi-Fi Aware to a second electronic device using the Wi-Fi Aware interface, receiving a second message corresponding to the first message from the second electronic device when the second electronic device triggers a Wi-Fi Aware interface based on the miracast-related information through Wi-Fi Aware, performing a mutual authentication procedure with the second electronic device, and transmitting Wi-Fi Aware-based data to the second electronic device.

### CROSS-REFERENCE TO RELATED APPLICATION(S)

This application is based on and claims priority under 35 U.S.C. § 119 (a) of a Korean patent application number 10-2024-0101096, filed on Jul. 30, 2024, in the Korean Intellectual Property Office, the disclosure of which is incorporated by reference herein in its entirety.

### BACKGROUND

### 1. Field

The disclosure relates to a method and device for providing a mirroring service based on wireless fidelity (Wi-Fi) communication.

### 2. Description of Related Art

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

Wi-Fi CERTIFIED Wi-Fi Aware™ (Wi-Fi Aware) is a technology that extends the capabilities of Wi-Fi by enabling rapid discovery, connection, and data exchange with other Wi-Fi devices without the need for traditional network infrastructure, Internet connection, or global positioning system (GPS) signals. Wi-Fi aware may provide the function of enabling a mutual search and direct connection between devices even without any other type of connection. Wi-Fi aware may also be referred to as neighbor awareness networking (NAN).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for providing a mirroring service based on wireless fidelity aware (Wi-Fi Aware) communication between electronic devices.

Additional aspects will be set forth in part in the description which follows and, in part, will be apparent from the description, or may be learned by practice of the presented embodiments.

In accordance with an aspect of the disclosure, a method performed by a first electronic device in a wireless communication system is provided. The method includes triggering a Wi-Fi Aware interface, transmitting a first message including miracast-related information through Wi-Fi Aware to a second electronic device using the Wi-Fi Aware interface, receiving a second message corresponding to the first message from the second electronic device when the second electronic device triggers a Wi-Fi Aware interface based on the miracast-related information through Wi-Fi Aware, performing a mutual authentication procedure with the second electronic device, and transmitting Wi-Fi Aware-based data to the second electronic device.

In accordance with another aspect of the disclosure, a method performed by a second electronic device in a wireless communication system is provided. The method includes receiving a first message including miracast-related information through Wi-Fi Aware from a first electronic device using a wireless fidelity direct (Wi-Fi Direct) interface, performing switching from the Wi-Fi Direct interface to a Wi-Fi Aware interface based on the miracast-related information through Wi-Fi Aware, transmitting a second message corresponding to the first message to the first electronic device using the Wi-Fi Aware interface, performing a mutual authentication procedure with the first electronic device, and receiving Wi-Fi Aware-based data from the first electronic device.

In accordance with another aspect of the disclosure, a first electronic device in a wireless communication system is provided. The first electronic device includes a transceiver, memory storing instructions, and one or more processors communicatively coupled to the transceiver and the memory. The instructions, when executed by the one or more processors individually or collectively, cause the first electronic device to trigger a Wi-Fi Aware interface, control to transmit a first message including miracast-related information through Wi-Fi Aware to a second electronic device using the Wi-Fi Aware interface, receive a second message corresponding to the first message from the second electronic device when the second electronic device triggers a Wi-Fi Aware interface based on the miracast-related information through Wi-Fi Aware, perform a mutual authentication procedure with the second electronic device, and control to transmit Wi-Fi Aware-based data to the second electronic device.

In accordance with another aspect of the disclosure, a second electronic device in a wireless communication system is provided. The second electronic device includes a transceiver, memory storing instructions, and one or more processors communicatively coupled to the transceiver and the memory. The instructions, when executed by the one or more processors individually or collectively, cause the second electronic device to receive a first message including miracast-related information through Wi-Fi Aware from a first electronic device using a Wi-Fi Direct interface, perform switching from the Wi-Fi Direct interface to a Wi-Fi Aware interface based on the miracast-related information through Wi-Fi Aware, control to transmit a second message corresponding to the first message to the first electronic device using the Wi-Fi Aware interface, perform a mutual authentication procedure with the first electronic device, and receive Wi-Fi Aware-based data from the first electronic device.

The disclosure provides a discovery method for providing a mirroring service based on Wi-Fi Aware communication or Wi-Fi Direct communication.

Further, the disclosure provides an authentication method for providing a mirroring service based on Wi-Fi Aware communication or Wi-Fi Direct communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a discovery procedure during Wi-Fi Direct communication according to an embodiment of the disclosure;

FIG. 2 is a view illustrating a discovery procedure during Wi-Fi Aware communication according to an embodiment of the disclosure;

FIG. 3 is a view illustrating an example of unsynchronized service discovery (USD) according to an embodiment of the disclosure;

FIG. 4 is a view illustrating another example of USD according to an embodiment of the disclosure;

FIG. 5 is a view illustrating yet another example of USD according to an embodiment of the disclosure;

FIG. 6 is a view illustrating an example of a USD-based Miracast procedure through Wi-Fi Aware triggering according to an embodiment of the disclosure;

FIG. 7 is a view illustrating another example of a USD-based Miracast procedure through Wi-Fi Direct triggering according to an embodiment of the disclosure;

FIG. 8 is a view illustrating an example of a Miracast procedure through Wi-Fi Direct triggering according to an embodiment of the disclosure;

FIG. 9 is a view illustrating a NAN connection procedure when a receiving device continuously scans Wi-Fi Direct according to an embodiment of the disclosure;

FIG. 10 is a flowchart illustrating a process of determining a device-to-device (D2D) connection according to an embodiment of the disclosure;

FIG. 11 is a view illustrating an example of a USD-based personal identification number (PIN) entering skip process according to an embodiment of the disclosure;

FIG. 12 is a view illustrating another example of a USD-based PIN entering skip process according to an embodiment of the disclosure;

FIG. 13 is a view illustrating yet another example of a USD-based PIN entering skip process according to an embodiment of the disclosure;

FIG. 14 is a view illustrating an architecture of an electronic device according to an embodiment of the disclosure;

FIG. 15 is a view illustrating a structure of a first electronic device according to an embodiment of the disclosure; and

FIG. 16 is a view illustrating a structure of a second electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the disclosure and may be replaced with other terms according to the intention or practice of the user or operator. Therefore, the terms should be defined based on the overall disclosure.

The terminology used herein is provided for a better understanding of the disclosure, and changes may be made thereto without departing from the technical spirit of the disclosure.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

The electronic device according to various embodiments of the disclosure may be one of various types of electronic devices. The electronic devices may include at least one of, e.g., a portable communication device (e.g., a smartphone), a computer device, a portable multimedia device, a portable medical device, a camera, a wearable device, or a home appliance (e.g., a television (TV)). According to an embodiment of the disclosure, the electronic devices are not limited to those described above.

Wi-Fi Direct is a Wi-Fi standard that enables electronic devices to be easily connected without a wireless access point. In the disclosure, Wi-Fi Direct may also be referred to as Wi-Fi peer-to-peer (P2P). An electronic device may perform internet browsing and/or file transfer through Wi-Fi Direct communication and may simultaneously communicate with one or more devices at general Wi-Fi speed levels (single radio hop communication). Wi-Fi Direct may be implemented by embedding a software access point called a soft access point (AP) in a device that needs to support Direct.

Wi-Fi Aware is a protocol that enables Wi-Fi devices to discover nearby services. Wi-Fi Aware may also be referred to as neighbor awareness networking (NAN). Generally, location-based services are based on querying a server to obtain information about the environment, and location knowledge is based on GPS or other location calculation technologies. However, Wi-Fi Aware does not require a real-time connection to a server, GPS, or other geographical locations, and instead may discover and exchange information using direct device-to-device Wi-Fi. Wi-Fi Aware scales effectively in dense Wi-Fi environments and may complement the connectivity of Wi-Fi by providing information about nearby people and services. Multiple Wi-Fi Aware devices in the vicinity may form a NAN cluster to communicate with each other.

Miracast is a standard for wirelessly connecting devices such as laptops, tablets, and smartphones to displays such as televisions or monitors. Miracast over Direct uses the P2P Wi-Fi Direct standard. The connection is made through Wi-Fi protected setup (WPS), so it is secured with Wi-Fi protected access 2 (WPA2), and Internet protocol version 4 (IPv4) may be used at the internet layer. Transmission control protocol (TCP) and user datagram protocol (UDP) are used at the transport layer, and at the application layer, streams may be initialized and controlled through real-time streaming protocol (RTSP) and real-time transport protocol (RTP) for data transmission.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

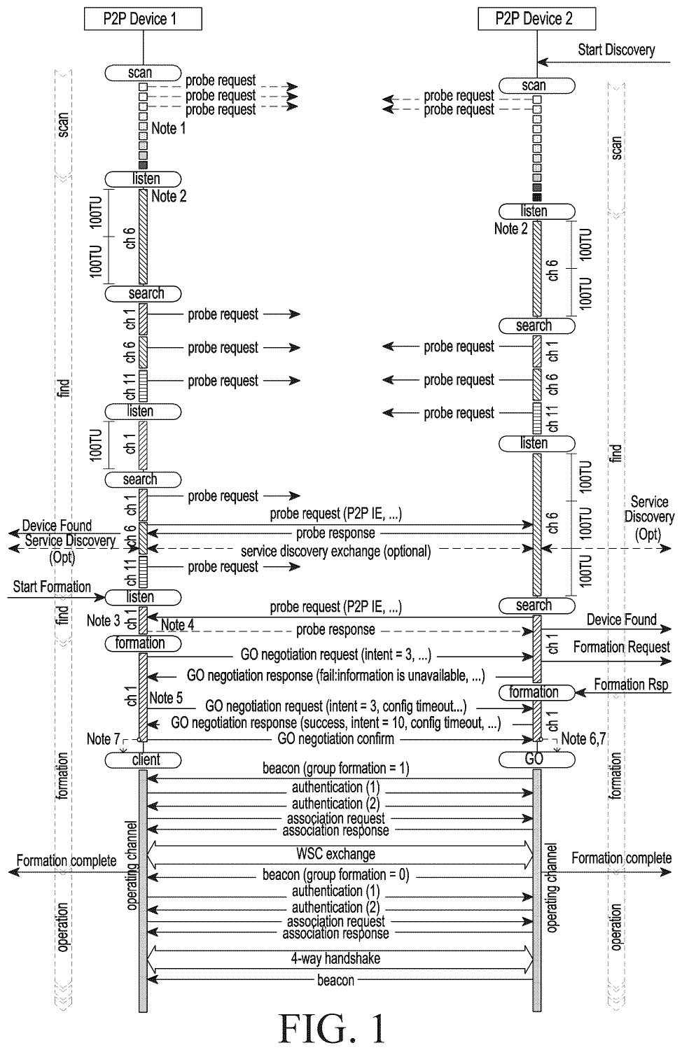

FIG. 1 is a view illustrating a discovery procedure during Wi-Fi Direct communication according to an embodiment of the disclosure.

Referring to FIG. 1, each of a first peer-to-peer (P2P) device and a second P2P device may perform at least one operation among scan, listen, search, formation, client, and group owner (GO) for Wi-Fi Direct communication.

Each of the first P2P device and the second P2P device may start a discovery operation. Each of the first P2P device and the second P2P device may transmit a probe request message at least once during the scan operation. According to an embodiment, each of the first P2P device and the second P2P device may activate or deactivate the scan operation.

During the listen operation, each of the first P2P device and the second P2P device may select a listen channel. For example, the first P2P device may select channel 1 as the listen channel, and the second P2P device may select channel 6 as the listen channel.

During the search operation, each of the first P2P device and the second P2P device may transmit a probe request message at least once on configured channels (e.g., social channels such as channel 1, channel 6, channel 11, etc.).

The first P2P device may enter a FIND listen state on the listen channel before transmitting a GO Negotiation request. For example, the first P2P device may receive a probe request message including a P2P information element (IE) from the second P2P device. The first P2P device may transmit a probe response message responding to the probe request message to the second P2P device.

Each of the first P2P device and the second P2P device may reach a common channel with each other through at least one search and listen operation.

During the formation operation, the first P2P device may transmit a GO Negotiation request message to the second P2P device on a configured channel (e.g., channel 1). The first P2P device may receive a GO Negotiation response message including information about GO Negotiation request failure (e.g., fail: information is unavailable) from the second P2P device on the configured channel (e.g., channel 1).

During the formation operation, the first P2P device may transmit a GO Negotiation request message to the second P2P device again on the configured channel (e.g., channel 1) after the initial GO Negotiation request failure. The first P2P device may receive a GO Negotiation response message including information about GO Negotiation request success from the second P2P device on the configured channel (e.g., channel 1). The first P2P device may transmit a GO Negotiation confirm message to the second P2P device on the configured channel (e.g., channel 1).

During the formation operation, the first P2P device may be determined to perform the operation of a client, and the second P2P device may be determined to perform the operation of a group owner (GO).

The first P2P device may receive a beacon including group information (e.g., group formation=1 or group formation=2) from the second P2P device on an operating channel for Wi-Fi Direct communication. The first P2P device may exchange authentication messages with the second P2P device. The first P2P device may transmit an association request message to the second P2P device and receive an association response message from the second P2P device. Thereafter, the first P2P device and the second P2P device may perform a 4-way handshake operation that exchanges four messages to generate an encryption key that may be used to encrypt actual data transmitted through the wireless medium.

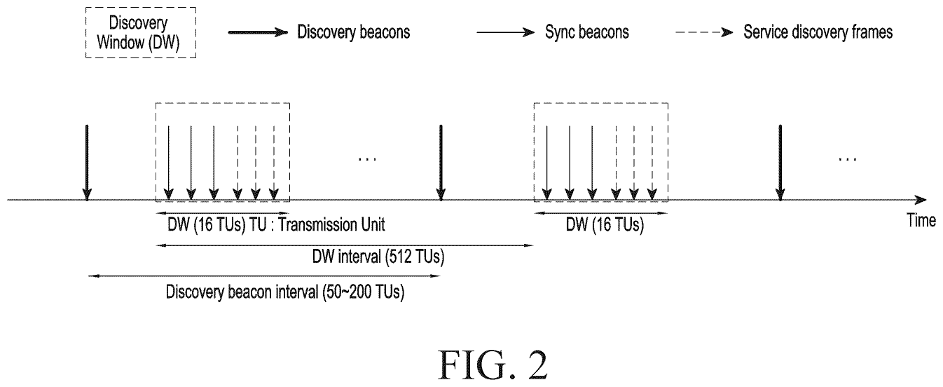

FIG. 2 is a view illustrating a discovery procedure during Wi-Fi Aware communication according to an embodiment of the disclosure.

Referring to FIG. 2, at least one electronic device included in a cluster may transmit a discovery beacon according to the NAN specification. The at least one electronic device may occupy 16 time units (TU) according to the NAN specification and transmit a synchronization beacon and a service discovery frame within a synchronized communication section (e.g., a discovery window (DW)) that is present at intervals of 512 time units (DW interval).

In an embodiment, the synchronization beacon may be a signal for maintaining synchronization (e.g., time clock synchronization) between electronic devices included in the cluster. The synchronization beacon may include at least one piece of information involved in synchronization between electronic devices. For example, the synchronization beacon may include at least one of a frame control (FC) field indicating a function of the signal (e.g., beacon), a broadcast address, a media access control (MAC) address of the electronic device that transmitted the synchronization beacon, a cluster identifier, a sequence control field, a time stamp for the beacon frame, a beacon interval field indicating an interval between start times of synchronized communication sections, or capability information of the electronic device that transmitted the synchronization beacon. Alternatively, the synchronization beacon may include at least one information element related to at least one proximity network, and may include, e.g., service-related content that may be provided based on the proximity network. According to the NAN specification, the synchronization beacon may be transmitted by an electronic device defined as an anchor master device, a master device, or a non-master sync device among at least one electronic device in the cluster.

In an embodiment, the service discovery frame may be a signal for advertising services between at least one electronic device in the cluster and exchanging information related to the services based on the proximity network. According to the NAN specification, the service discovery frame is a vendor specific public action frame and may include various fields. For example, the service discovery frame may include information elements related to at least one proximity network.

In an embodiment, the at least one electronic device may transmit a discovery beacon within a section other than the DW section. The discovery beacon may be a signal with a cluster advertisement function transmitted so that at least one other electronic device that has not joined the cluster may discover the cluster. For example, the at least one other electronic device that has not joined the cluster may discover and join the cluster by performing a passive scan to detect a discovery beacon transmitted from at least one electronic device participating in the cluster. In this regard, the discovery beacon may include at least one piece of information for synchronizing with the cluster. For example, the discovery beacon may include at least one of a frame control (FC) field indicating a function of the signal (e.g., beacon), a broadcast address, a media access control (MAC) address of the electronic device that transmitted the discovery beacon, a cluster identifier, a sequence control field, a time stamp for the beacon frame, a discovery beacon interval field indicating a transmission interval of the discovery beacon, or capability information of the electronic device that transmitted the discovery beacon. Alternatively, the discovery beacon may include information elements related to at least one proximity network.

In an embodiment, the discovery window (DW) may occupy 16 TU, and the DW interval, which is a time interval between discovery windows, may occupy 512 TU. Further, a discovery beacon interval indicating a transmission interval of the discovery beacon may occupy 50 to 200 TU.

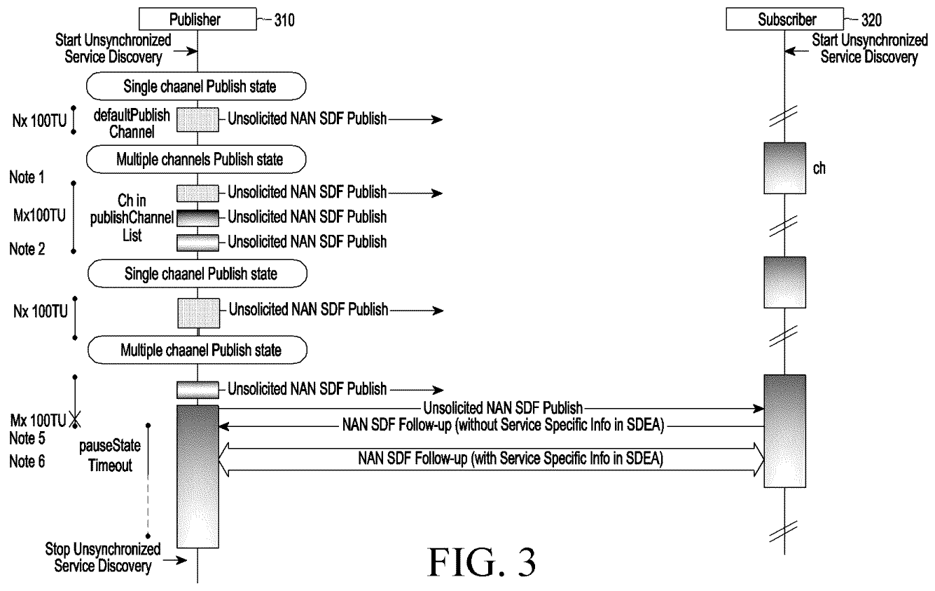

FIG. 3 is a view illustrating an example of unsynchronized service discovery (USD) according to an embodiment of the disclosure.

Referring to FIG. 3, a first electronic device 310 is a Wi-Fi aware device that performs a publisher role, and a second electronic device 320 may be a Wi-Fi aware device that performs a passive subscriber role.

Each of the first electronic device 310 and the second electronic device 320 may start USD.

When the first electronic device 310 is in a single channel publish state, the first electronic device 310 may transmit an Unsolicited NAN service discovery frame (SDF) Publish message within N*100 TU on a default channel (defaultPublish Channel) (e.g., channel 6 in the 2.4 gigahertz (GHz) band). When the first electronic device 310 is in a multiple channel publish state, the first electronic device 310 may transmit at least one Unsolicited NAN SDF Publish message within M*100 TU on a channel in a channel list (publishChannel List). According to an embodiment, N and M may be integers within a range of [5, 10]. According to an embodiment, N and M may be randomly selected. According to an embodiment, the channel list (publishChannel List) may include all 20 megahertz (MHx) channels in the 2.4 GHz band and/or all 20 MHz channels in the 5GHz band.

Thereafter, when the first electronic device 310 is again in a single channel publish state, the first electronic device 310 may transmit an Unsolicited NAN SDF Publish message within N*100 TU on the default channel (e.g., channel 6 in the 2.4 GHz band).

When the first electronic device 310 is in a multiple channel publish state, the first electronic device 310 may transmit an Unsolicited NAN SDF Publish message on a channel in the channel list. The second electronic device 320 may receive the Unsolicited NAN SDF Publish message from the first electronic device 310 and transmit a NAN SDF Follow-up message that does not include service specific information in a service descriptor extension attribute (SDEA) to the first electronic device 310.

The first electronic device 310 and the second electronic device 320 may exchange at least one message for NAN SDF Follow-up. According to an embodiment, the second electronic device 320 may transmit a NAN SDF Follow-up message including service specific information in the SDEA to the first electronic device 310.

According to an embodiment, the first electronic device 310 may stop USD when a configured timer expires (pauseState Timeout).

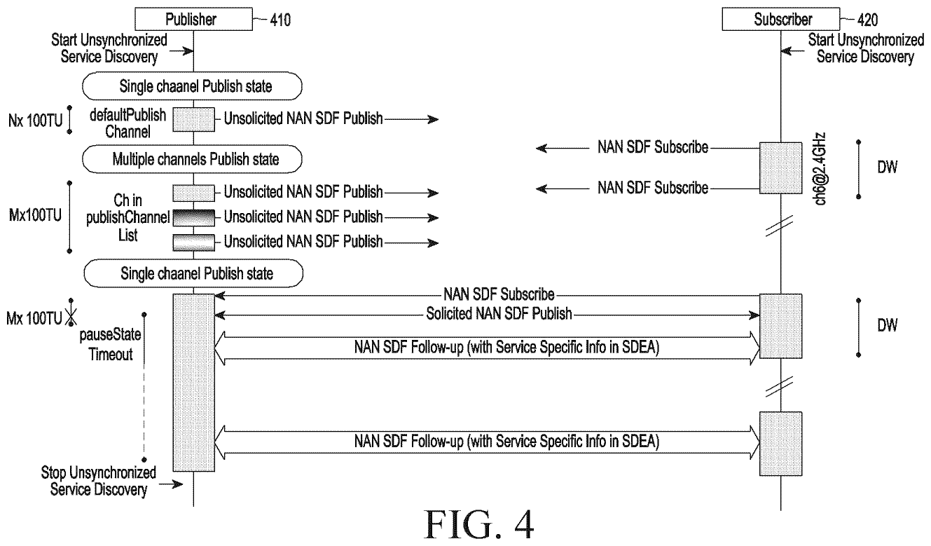

FIG. 4 is a view illustrating another example of USD according to an embodiment of the disclosure.

Referring to FIG. 4, a first electronic device 410 is a wireless fidelity (Wi-Fi) aware device that performs a publisher role, and a second electronic device 420 may be a Wi-Fi aware device that performs an active subscriber role.

Each of the first electronic device 410 and the second electronic device 420 may start USD.

When the first electronic device 410 is in a single channel publish state, the first electronic device 410 may transmit an Unsolicited NAN SDF Publish message within N*100 TU on a default channel (defaultPublish Channel) (e.g., channel 6 in the 2.4 GHz band). When the first electronic device 410 is in a multiple channel publish state, the first electronic device 410 may transmit at least one Unsolicited NAN SDF Publish message within M*100 TU on a channel in a channel list (publishChannel List). The second electronic device 420 may transmit at least one NAN SDF Subscribe message within a discovery window (DW) on the default channel (e.g., channel 6 in the 2.4 GHz band).

According to an embodiment, N and M may be integers within a range of [5, 10]. According to an embodiment, N and M may be randomly selected. According to an embodiment, the channel list (publishChannel List) may include all 20 MHz channels in the 2.4 GHz band and/or all 20 MHz channels in the 5 GHz band.

Thereafter, when the first electronic device 410 is again in a single channel publish state, the second electronic device 320 may transmit a NAN SDF Subscribe message to the first electronic device 410. The first electronic device 410 may transmit a solicited NAN SDF Publish message to the second electronic device 420. The first electronic device 410 and the second electronic device 420 may exchange at least one message for NAN SDF Follow-up. According to an embodiment, the second electronic device 420 may transmit a NAN SDF Follow-up message including service specific information in the SDEA to the first electronic device 410.

According to an embodiment, the first electronic device 410 may stop USD when a configured timer expires (pauseState Timeout).

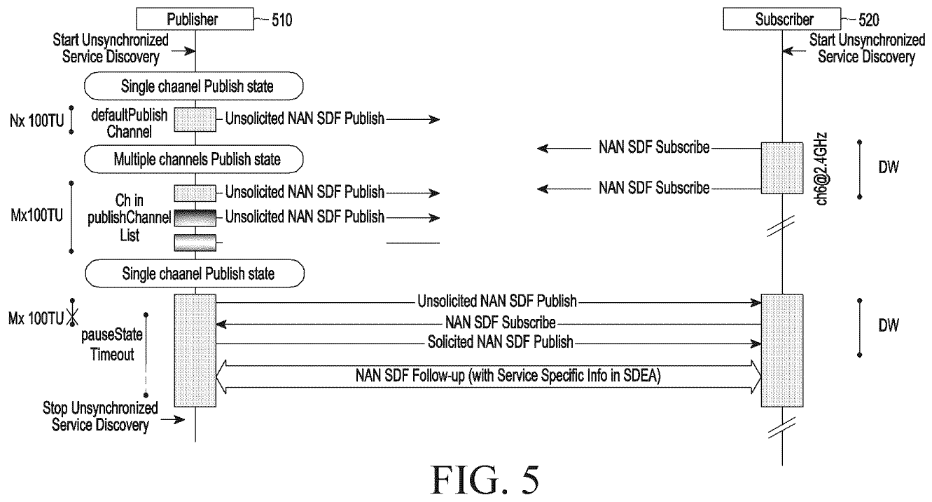

FIG. 5 is a view illustrating yet another example of USD according to an embodiment of the disclosure.

Referring to FIG. 5, a first electronic device 510 is a Wi-Fi aware device that performs a publisher role, and a second electronic device 520 may be a Wi-Fi aware device that performs an active subscriber role.

Each of the first electronic device 510 and the second electronic device 520 may start USD.

When the first electronic device 510 is in a single channel publish state, the first electronic device 510 may transmit an Unsolicited NAN SDF Publish message within N*100 TU on a default channel (defaultPublish Channel) (e.g., channel 6 in the 2.4 GHz band). When the first electronic device 510 is in a multiple channel publish state, the first electronic device 510 may transmit at least one Unsolicited NAN SDF Publish message within M*100 TU on a channel in a channel list (publishChannel List). The second electronic device 520 may transmit at least one NAN SDF Subscribe message on the default channel (e.g., channel 6 in the 2.4 GHz band).

According to an embodiment, N and M may be integers within a range of [5, 10]. According to an embodiment, N and M may be randomly selected. According to an embodiment, the channel list (publishChannel List) may include all 20 MHz channels in the 2.4 GHz band and/or all 20 MHz channels in the 5 GHz band.

Thereafter, when the first electronic device 510 is again in a single channel publish state, the first electronic device 510 may transmit an Unsolicited NAN SDF Publish message to the second electronic device 520. The second electronic device 520 may transmit a NAN SDF Subscribe message to the first electronic device 510, and the first electronic device 510 may transmit a solicited NAN SDF Publish message to the second electronic device 520. The first electronic device 510 and the second electronic device 520 may exchange at least one message for NAN SDF Follow-up. According to an embodiment, the second electronic device 520 may transmit a NAN SDF Follow-up message including service specific information in the SDEA to the first electronic device 510.

According to an embodiment, the first electronic device 510 may stop USD when a configured timer expires (pauseState Timeout).

Meanwhile, wireless local area network (WLAN)/P2P mode may be constantly operated for P2P (Wi-Fi Direct) based mirroring between a mobile device and a display device (e.g., TV). However, when implementing Miracast over Aware using Wi-Fi Aware communication, constraints (e.g., in terms of cost and/or performance) may occur in the simultaneous operation of WLAN/P2P/Aware.

The disclosure proposes a method of basically operating WLAN and selectively activating P2P/Aware for mirroring between a mobile device and a display device (e.g., TV). An efficient protocol may be needed to start a Miracast over Aware service that minimizes WLAN/P2P performance loss.

The disclosure proposes Wi-Fi inband discovery for mirroring between a mobile device and a display device (e.g., TV). When a mobile device starts Wi-Fi Aware/Direct USD, information necessary for Miracast over Aware operation (e.g., service/device information, radio operation information, and/or authentication information) may be included and transmitted in a service descriptor extension attribute (SDEA) or vendor specific IE (VSIE) field within an SDF Publish message.

According to an embodiment, Wi-Fi Aware/Direct common USD may be performed based on a Bluetooth low energy (BLE) Triggered method for mirroring between a mobile device and a display device (e.g., TV).

According to an embodiment, a method of selectively utilizing Wi-Fi Aware/Direct may be performed for mirroring between a mobile device and a display device (e.g., TV).

According to an embodiment, for mirroring between a mobile device and a display device (e.g., TV), Wi-Fi Aware USD may be utilized, and a driver that does not filter organizational OUI type: 0x13 (Identifying the type and version of NAN IE) in legacy Wi-Fi Direct devices may be configured. According to an embodiment, for mirroring between a mobile device and a display device (e.g., TV), Wi-Fi Aware USD may be utilized, and a configured OUI type (message transmission changed to Wi-Fi Direct) may be used.

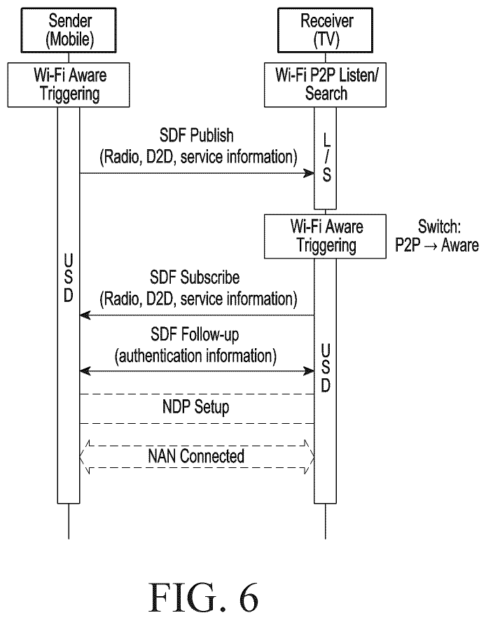

FIG. 6 is a view illustrating an example of a USD-based Miracast procedure through Wi-Fi Aware triggering according to an embodiment of the disclosure.

Referring to FIG. 6, a first electronic device (Sender) (e.g., mobile device) may trigger a Wi-Fi Aware module. A second electronic device (Receiver) (e.g., TV) may perform a Listen and/or Search operation through a Wi-Fi Direct (or P2P) module.

According to an embodiment, the first electronic device (Sender) (e.g., mobile device) may execute an upper application for Miracast over Aware and trigger a Wi-Fi Aware interface. According to another embodiment, the first electronic device (Sender) (e.g., mobile device) may trigger a Direct/Aware simultaneous operation mode.

The first electronic device (Sender) (e.g., mobile device) may transmit an SDF Publish message including Miracast over Aware related information to the second electronic device (Receiver) (e.g., TV) through USD. According to an embodiment, the Miracast over Aware related information may include at least one of Radio information, D2D information, and service information.

The second electronic device (Receiver) (e.g., TV) in a P2P Listen/Search state may receive at least one of Radio information, D2D information, and service information included in the SDF Publish message (prerequisite: Aware SDF handling possible in P2P interface).

The second electronic device (Receiver) (e.g., TV) may switch from the P2P interface to the Wi-Fi Aware interface. According to an embodiment, the second electronic device (Receiver) (e.g., TV) may execute an upper application for Miracast over Aware and trigger a Wi-Fi Aware interface. According to another embodiment, the second electronic device (Receiver) (e.g., TV) may trigger a Direct/Aware simultaneous operation mode.

The second electronic device (Receiver) (e.g., TV) may transmit an SDF subscribe message including Miracast over Aware related information to the first electronic device (Sender) (e.g., mobile device) through USD. According to an embodiment, the Miracast over Aware related information may include at least one of Radio information, D2D information, and service information.

The first electronic device (Sender) (e.g., mobile device) and the second electronic device (Receiver) (e.g., TV) may exchange SDF follow-up messages including authentication information. Thereafter, the first electronic device (Sender) (e.g., mobile device) and the second electronic device (Receiver) (e.g., TV) may perform a NAN data path (NDP) setup procedure. The NDP setup procedure may include an authentication procedure. Thereafter, a NAN connection may be established between the first electronic device (Sender) (e.g., mobile device) and the second electronic device (Receiver) (e.g., TV).

According to an embodiment, Service Info included in the SDF Publish message or SDF subscribe message may be included in a service descriptor extension attribute (SDEA) within the corresponding message.

According to an embodiment, the format of the SDEA including Service Info may be configured as illustrated in Table 1.

TABLE 1

| | Size | | |
|---|---|---|---|
| Field | (Octets) | Value | Description |
| Attribute | 1 | 0x0E | Identifies the type of NAN attribute. |
| ID | | | |
| Length | 2 | Variable | Length of the following fields in the attribute. |
| Instance | 1 | Variable | The same value as in the Instance ID field of the |
| ID | | | associated Service Descriptor attribute. |
| Control | 2 | Variable | Information about the fields present. |
| Range | 0 or 4 | Variable | Range limit given in centimeters. This is an |
| Limit | | | optional field. |
| Service | 0 or 1 | Variable | Monotonically increasing value indicating the |
| Update | | | current version of the service specific information |
| Indicator | | | corresponding to the publish instance, which may |
| | | | be conveyed by publish messages and/or FSD |
| | | | messages. This is an optional field. |
| Service | 0 or 2 | Variable | Length of the Service Info field. An optional field |
| Info | | | and present if Service Info field is present. |
| Length | | | |
| Service | Variable | Variable | An optional field that contains the service specific |
| Info | | | information. |

According to an embodiment, the service information may include a Wi-Fi Alliance specific organizational unique identifier (OUI) field, a service protocol type field, and a service specific info field.

According to an embodiment, the service protocol type field may be set to one value among 0 to 255. According to an embodiment, if the service protocol type field is 0, it indicates Reserved; if the service protocol type field is 1, it indicates Bonjour; if the service protocol type field is 2, it indicates Generic; if the service protocol type field is 3, it indicates channel switch announcement (CSA) Matter; and if the service protocol type field is one of 4 to 255, it may indicate Reserved. According to an embodiment, the service protocol type field may be set to one of 4 to 255 to indicate Miracast over Aware (newly defining Miracast service utilizing Reserved field). According to an embodiment, the service protocol type field may be set to 2 to indicate Miracast over Aware (considered as Generic Service).

According to an embodiment, the service specific info field may include at least one of Sub-attribute ID (e.g., 0x02—Service Name), Value (e.g., _display._tcp—Miracast over Wi-Fi Aware), and Sub-attribute ID (e.g., 0x03—Name of the Service Instance).

According to an embodiment, a vendor specific IE (VSIE) may include an Attribute ID field, a Length field, an OUI field, a Vendor Specific OUI Type field, and a Vendor Specific Data field. According to an embodiment, the VSIE may be included in the SDEA. According to an embodiment, the OUI field indicates a Vendor OUI, and the Vendor Specific OUI Type field may be differently allocated according to a service type (e.g., Smart View). According to an embodiment, the Vendor Specific Data field may include one or more attributes for the vendor specific IE.

According to an embodiment, the vendor specific attribute may include an Attribute ID field, a Length field, an OUI field, and a Body field. According to an embodiment, the Attribute ID field may indicate a type of NAN attribute. According to an embodiment, the Length field may indicate lengths of fields included in the vendor specific attribute. According to an embodiment, the OUI field may indicate a Vendor Specific OUI. According to an embodiment, the Body field may include implemented vendor specific information.

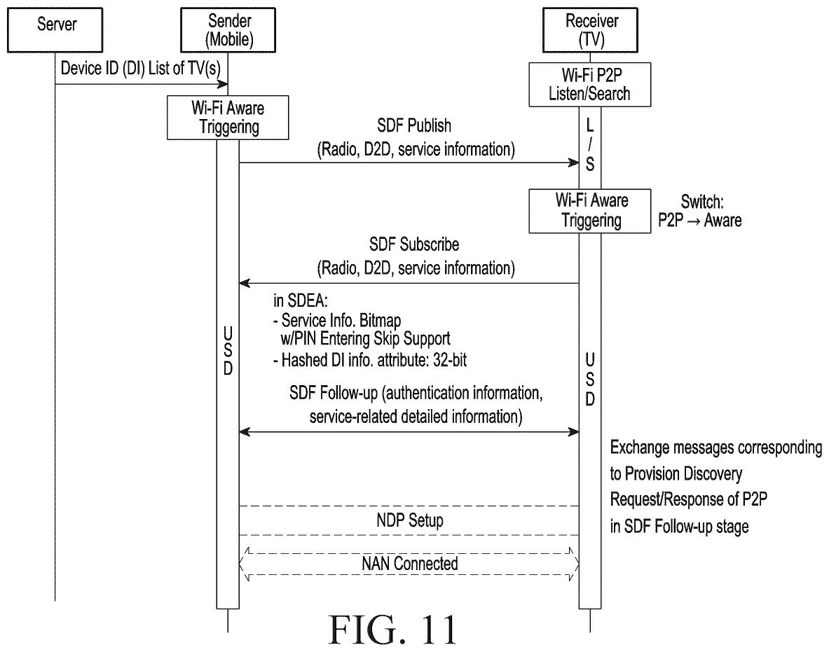

According to an embodiment, a Service Information attribute according to Vendor Specific OUI Type may include an Attribute ID field, a Length field, and an Info. bitmap field. According to an embodiment, the Attribute ID field may indicate Device WLAN/D2D information. According to an embodiment, the Info. bitmap field may indicate whether PIN Entering SKIP described below in FIGS. 11 to 13 is supported.

According to an embodiment, a Service Information attribute according to Vendor Specific OUI Type may include an Attribute ID field, a Length field, an Associated AP basic service set identifier (BSSID) field, and a Radio info. bitmap field. According to an embodiment, the Attribute ID field may indicate Device WLAN/D2D information. According to an embodiment, the Associated AP BSSID field may indicate an Associated AP BSSID MAC address. According to an embodiment, the Radio info. bitmap field may indicate WLAN/D2D information.

According to an embodiment, the Radio info. bitmap field may include at least one of connected AP information (e.g., connected AP channel/band information), Band Capability information, real simultaneous dual band (RSDB) Capability information, capability information (indicating support for at least one of Dual P2P, SoftAP+P2P, Concurrent), connection status information (at least one of P2P Status information, NAN operation status, SoftAP operation status, tunneled direct link setup (TDLS) operation status, Concurrent operation status), and Reserved. According to an embodiment, the Radio info. bitmap field may be included in the SDEA.

According to an embodiment, a Service Information attribute according to Vendor Specific OUI Type may include an Attribute ID field, a Length field, and a Mobile/TV ID field. According to an embodiment, the Attribute ID field may indicate Device identification information. According to an embodiment, the Mobile/TV ID field may indicate specific identification information for the device.

According to an embodiment, the SDEA may include authentication related information. The authentication related information may include at least one of a Device Id (DI) information attribute and an Encrypted PIN information attribute.

According to an embodiment, the DI information attribute may include an Attribute ID field, a Length field, and a Hashed Device Id (DI) field. According to an embodiment, the Attribute ID field may indicate Vendor specific identification information. According to an embodiment, the Hashed DI may be a 128-bit Device ID obtained from an IoT Cloud and/or Server.

According to an embodiment, the Encrypted PIN information attribute may include an Attribute ID field, a Length field, an Encrypted PIN field, and a VI field. According to an embodiment, the Attribute ID field may indicate Vendor specific identification information. According to an embodiment, the Encrypted PIN field may indicate AES256-CBC-Encrypt (64-bit PIN∥48-bit MAC address of mobile's P2P or Aware interface∥16-bit randomly generated padding). According to an embodiment, the VI field may be a randomly generated 128-bit binary value.

According to an embodiment, the SDEA may include authentication information. The authentication information may include an Encrypted PIN Status information attribute. According to an embodiment, the Encrypted PIN Status information attribute may include an Attribute ID field, a Length field, and a Status field. According to an embodiment, the Attribute ID field may indicate Vendor specific identification information. According to an embodiment, the Status field may indicate success or failure of the Encrypted PIN (e.g., 0x00: Success, 0x01: Failure, 0x02˜0xFF: Reserved).

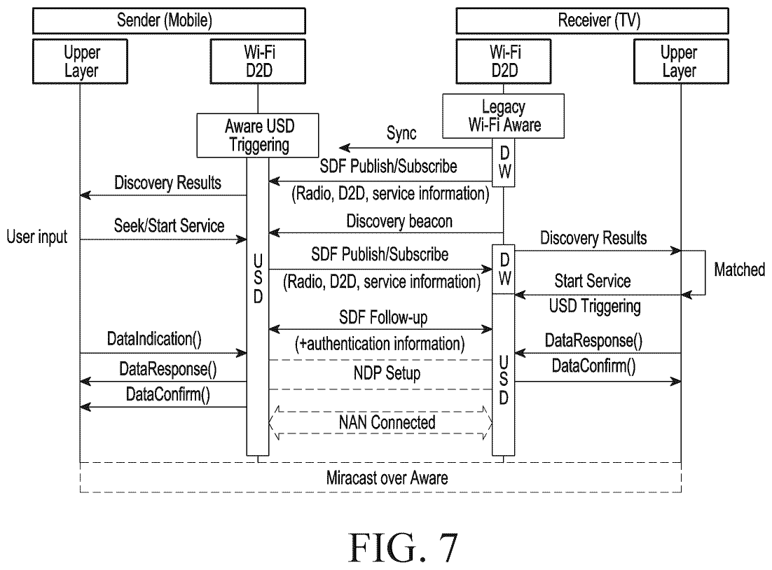

FIG. 7 is a view illustrating another example of a USD-based Miracast procedure through Wi-Fi Direct triggering according to an embodiment of the disclosure.

Referring to FIG. 7, a first electronic device (Sender) (e.g., mobile device) and a second electronic device (Receiver) (e.g., TV) may include an upper layer module and a Wi-Fi D2D module. According to an embodiment, the upper layer module may include an application layer and a framework layer. The framework layer may include Wi-Fi service layers (e.g., Wi-Fi Station (STA), Wi-Fi Aware, and/or Wi-Fi Direct) supported by an operating system (OS). According to an embodiment, the Wi-Fi D2D module may include a Wi-Fi interface layer and a firmware layer.

The first electronic device (Sender) (e.g., mobile device) may trigger a Wi-Fi Aware module for USD. A second electronic device (Receiver) (e.g., TV) may be in a state of constantly operating the Wi-Fi Aware module.

The second electronic device (Receiver) (e.g., TV) may transmit a synchronization beacon while constantly operating the Wi-Fi Aware DW. The second electronic device (Receiver) (e.g., TV) may transmit an SDF Publish message (or SDF Subscribe message) including SDEA and/or VSIE to the first electronic device (Sender) (e.g., mobile device) within the Wi-Fi Aware DW. According to an embodiment, the SDEA (or the VSIE) may include at least one of Radio information, D2D information, and service information. Thereafter, the second electronic device (Receiver) (e.g., TV) may transmit a discovery beacon after the Wi-Fi Aware DW.

The Wi-Fi D2D module in the first electronic device (Sender) (e.g., mobile device) delivers discovery result information to the upper layer module, and the upper layer module may deliver information instructing to seek/start service to the Wi-Fi D2D module based on user input.

The first electronic device (Sender) (e.g., mobile device) may transmit an SDF Subscribe message (or SDF Publish message) including Miracast over Aware related information to the second electronic device (Receiver) (e.g., TV) through USD. According to an embodiment, the Miracast over Aware related information may include at least one of Radio information, D2D information, and service information.

After receiving the SDF Subscribe message (or SDF Publish message) transmitted by the first electronic device (Sender) (e.g., mobile device), the second electronic device (Receiver) (e.g., TV) may execute an upper service/application for Miracast over Aware and perform Wi-Fi Aware USD.

The Wi-Fi D2D module in the second electronic device (Receiver) (e.g., TV) delivers discovery result information to the upper layer module, and the upper layer module may deliver information instructing to start service to the Wi-Fi D2D module based on the Miracast over Aware related information received from the first electronic device (Sender) (e.g., mobile device). Thereafter, the second electronic device (Receiver) (e.g., TV) may trigger USD.

The first electronic device (Sender) (e.g., mobile device) and the second electronic device (Receiver) (e.g., TV) may exchange SDF follow-up messages including authentication information through USD.

The first electronic device (Sender) (e.g., mobile device) and the second electronic device (Receiver) (e.g., TV) may perform a NAN data path (NDP) setup procedure. The NDP setup procedure may include an authentication procedure.

The upper layer module in the first electronic device (Sender) (e.g., mobile device) may deliver DataIndication() to the Wi-Fi D2D module, and in response, the Wi-Fi D2D module may deliver DataResponse() to the upper layer module. The Wi-Fi D2D module in the first electronic device (Sender) (e.g., mobile device) may deliver DataConfirm() to the upper layer module.

The upper layer module in the second electronic device (Receiver) (e.g., TV) may deliver DataRequest() to the Wi-Fi D2D module, and in response, the Wi-Fi D2D module may deliver DataConfirm() to the upper layer module.

After a NAN connection is established between the first electronic device (Sender) (e.g., mobile device) and the second electronic device (Receiver) (e.g., TV), each of the first electronic device (Sender) (e.g., mobile device) and the second electronic device (Receiver) (e.g., TV) may perform Miracast over Aware operation.

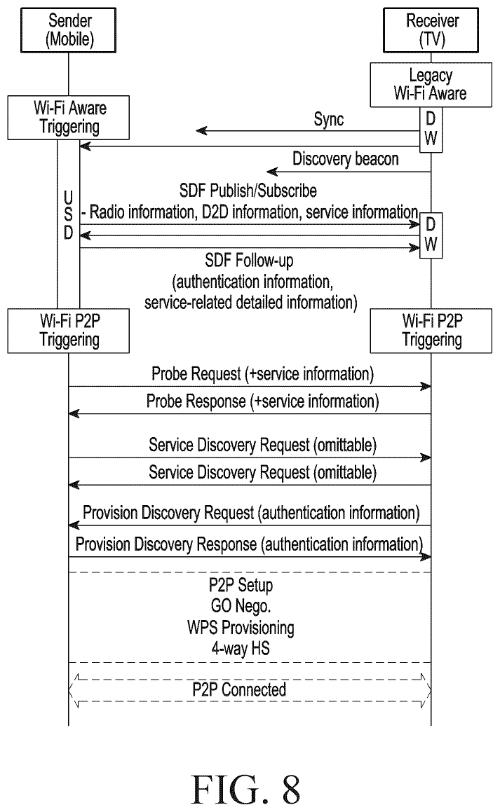

FIG. 8 is a view illustrating an example of a Miracast procedure through Wi-Fi Direct triggering according to an embodiment of the disclosure.

Referring to FIG. 8, a first electronic device (Sender) (e.g., mobile device) may trigger a Wi-Fi Aware module for USD. A second electronic device (Receiver) (e.g., TV) may be in a state of constantly operating the Wi-Fi Aware module. For example, the first electronic device (Sender) (e.g., mobile device) may perform USD through one of preconfigured channels (e.g., Ch.6, Ch. 44, or Ch. 149). For example, the second electronic device (Receiver) (e.g., TV) may operate the DW within a configured channel (e.g., Ch.6).

The second electronic device (Receiver) (e.g., TV) may transmit a synchronization beacon while constantly operating the Wi-Fi Aware DW. The second electronic device (Receiver) (e.g., TV) may transmit an SDF Publish message (or SDF Subscribe message) including SDEA and/or VSIE to the first electronic device (Sender) (e.g., mobile device) within the Wi-Fi Aware DW. According to an embodiment, the SDEA (or the VSIE) may include at least one of Radio information, D2D information, and service information. Thereafter, the second electronic device (Receiver) (e.g., TV) may transmit a discovery beacon after the Wi-Fi Aware DW.

The first electronic device (Sender) (e.g., mobile device) may transmit an SDF Subscribe message (or SDF Publish message) including Miracast over Aware related information to the second electronic device (Receiver) (e.g., TV) through USD. According to an embodiment, the Miracast over Aware related information may include at least one of Radio information, D2D information, and service information.

The first electronic device (Sender) (e.g., mobile device) and the second electronic device (Receiver) (e.g., TV) may exchange SDF follow-up messages including authentication information through USD.

After receiving the SDF Subscribe message (or SDF Publish message) transmitted by the second electronic device (Receiver) (e.g., TV), the first electronic device (Sender) (e.g., mobile device) may execute an upper service/application for Miracast over Direct and trigger Wi-Fi P2P.

After receiving the SDF Subscribe message (or SDF Publish message) transmitted by the first electronic device (Sender) (e.g., mobile device), the second electronic device (Receiver) (e.g., TV) may execute an upper service/application for Miracast over Direct and trigger Wi-Fi P2P.

The first electronic device (Sender) (e.g., mobile device) may transmit a Probe Request message including service information to the second electronic device (Receiver) (e.g., TV). The second electronic device (Receiver) (e.g., TV) may transmit a Probe Response message including service information to the first electronic device (Sender) (e.g., mobile device).

According to an embodiment, the first electronic device (Sender) (e.g., mobile device) may transmit a Service Discovery Request message to the second electronic device (Receiver) (e.g., TV). According to an embodiment, the second electronic device (Receiver) (e.g., TV) may transmit a Service Discovery Response message to the first electronic device (Sender) (e.g., mobile device). According to an embodiment, when information is exchanged first in the Aware stage, some subsequent P2P procedures may be omitted, and the transmission/reception process of the Service Discovery Request message and/or Service Discovery Response message may be omitted.

The first electronic device (Sender) (e.g., mobile device) may transmit a Provision Discovery Request message including authentication information to the second electronic device (Receiver) (e.g., TV). The second electronic device (Receiver) (e.g., TV) may transmit a Provision Discovery Response message including authentication information to the first electronic device (Sender) (e.g., mobile device). According to an embodiment, when information is exchanged first in the Aware stage, some subsequent P2P procedures may be omitted, and the transmission/reception process of the Provision Discovery Request message and/or Provision Discovery Response message may be omitted.

The first electronic device (Sender) (e.g., mobile device) and the second electronic device (Receiver) (e.g., TV) may perform a P2P setup procedure. According to an embodiment, the first electronic device (Sender) (e.g., mobile device) and the second electronic device (Receiver) (e.g., TV) may exchange GO Negotiation request messages/GO Negotiation response messages. According to an embodiment, the first electronic device (Sender) (e.g., mobile device) and the second electronic device (Receiver) (e.g., TV) may perform a Wi-Fi Protected Setup (WPS) provisioning procedure. According to an embodiment, the first electronic device (Sender) (e.g., mobile device) and the second electronic device (Receiver) (e.g., TV) may perform a 4-way handshake operation that exchanges four messages to generate an encryption key that may be used to encrypt actual data transmitted through the wireless medium. Thereafter, a P2P connection may be established between the first electronic device (Sender) (e.g., mobile device) and the second electronic device (Receiver) (e.g., TV).

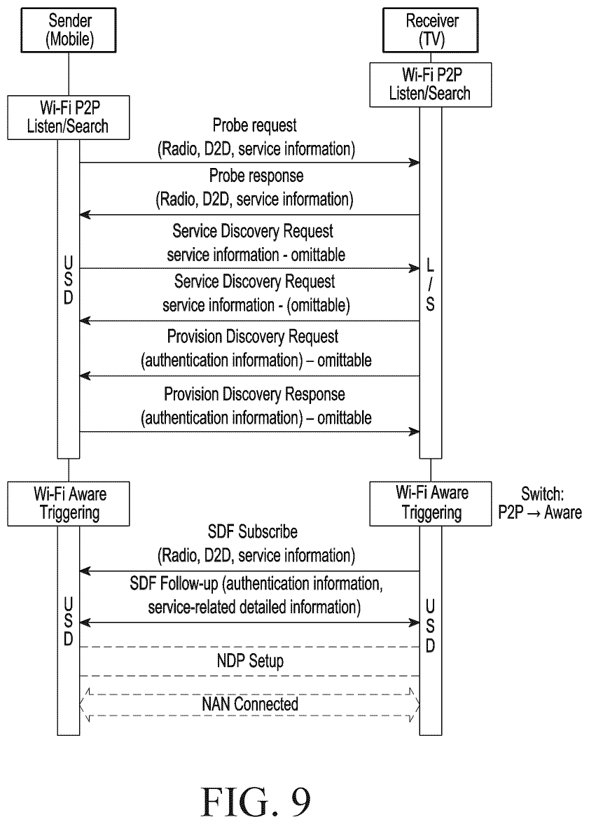

FIG. 9 is a view illustrating a NAN connection procedure when a receiving device continuously scans Wi-Fi Direct according to an embodiment of the disclosure.

Referring to FIG. 9, a first electronic device (Sender) (e.g., mobile device) and a second electronic device (Receiver) (e.g., TV) may perform a Listen and/or Search operation through a Wi-Fi Direct (or P2P) module. For example, the Listen operation may be performed on channel 6, and the Search operation may be performed on any one of channel 1, channel 6, and channel 11.

The first electronic device (Sender) (e.g., mobile device) may transmit a Probe request message including at least one of Radio information, D2D information, and service information to the second electronic device (Receiver) (e.g., TV).

The second electronic device (Receiver) (e.g., TV) may transmit a Probe response message including at least one of Radio information, D2D information, and service information to the first electronic device (Sender) (e.g., mobile device).

The first electronic device (Sender) (e.g., mobile device) may transmit a Service Discovery Request message to the second electronic device (Receiver) (e.g., TV). The second electronic device (Receiver) (e.g., TV) may transmit a Service Discovery Response message to the first electronic device (Sender) (e.g., mobile device). According to an embodiment, the transmission/reception process of the Service Discovery Request message and/or Service Discovery Response message may be omitted.

The first electronic device (Sender) (e.g., mobile device) may transmit a Provision Discovery Request message including authentication information to the second electronic device (Receiver) (e.g., TV). The second electronic device (Receiver) (e.g., TV) may transmit a Provision Discovery Response message including authentication information to the first electronic device (Sender) (e.g., mobile device). According to an embodiment, the transmission/reception process of the Provision Discovery Request message and/or Provision Discovery Response message may be omitted.

Each of the first electronic device (Sender) (e.g., mobile device) and the second electronic device (Receiver) (e.g., TV) may trigger a Wi-Fi Aware interface. According to an embodiment, each of the first electronic device (Sender) (e.g., mobile device) and the second electronic device (Receiver) (e.g., TV) may perform a switching operation from the P2P interface to the Wi-Fi Aware interface.

The second electronic device (Receiver) (e.g., TV) may transmit an SDF subscribe message including Miracast over Aware related information to the first electronic device (Sender) (e.g., mobile device) through USD. According to an embodiment, the Miracast over Aware related information may include at least one of Radio information, D2D information, and service information.

The first electronic device (Sender) (e.g., mobile device) and the second electronic device (Receiver) (e.g., TV) may exchange SDF follow-up messages including authentication information. Thereafter, the first electronic device (Sender) (e.g., mobile device) and the second electronic device (Receiver) (e.g., TV) may perform a NAN data path (NDP) setup procedure. The NDP setup procedure may include an authentication procedure. Thereafter, a NAN connection may be established between the first electronic device (Sender) (e.g., mobile device) and the second electronic device (Receiver) (e.g., TV).

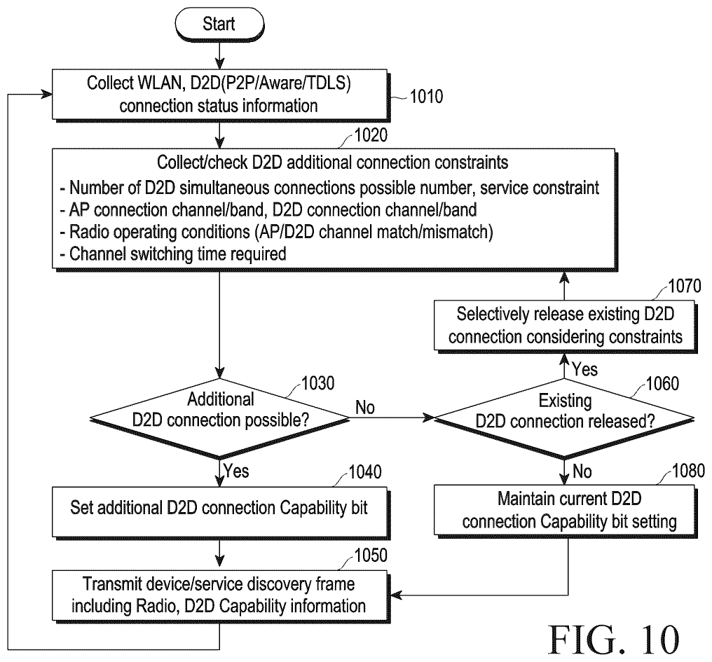

FIG. 10 is a flowchart illustrating a process of determining a D2D connection according to an embodiment of the disclosure.

Referring to FIG. 10, in operation 1010, an electronic device may collect WLAN connection status and D2D (e.g., at least one of Wi-Fi Direct (P2P), Wi-Fi Aware, and tunneled direct link setup (TDLS)) connection status information.

In operation 1020, the electronic device may collect and/or identify D2D additional connection constraints. According to an embodiment, the D2D additional connection constraints may include at least one of the number of D2D simultaneous connections possible, service constraints, AP connection channel and/or band, D2D connection channel and/or band, Radio operation conditions (AP/D2D channel match/mismatch), and channel switching time required.

In operation 1030, the electronic device may identify whether an additional D2D connection is possible.

If an additional D2D connection is possible (1030—Yes), in operation 1040, the electronic device may set a Capability bit for the additional D2D connection. In operation 1050, the electronic device may transmit a device/service discovery frame including Radio information and D2D Capability information.

If an additional D2D connection is not possible (1030—No), in operation 1060, the electronic device may determine whether to release an existing D2D connection.

If it is determined to release the existing D2D connection (1060—Yes), in operation 1070, the electronic device may selectively release the existing D2D connection considering constraints. Thereafter, the electronic device may perform operation 1020 again.

If it is determined not to release the existing D2D connection (1060—No), in operation 1080, the electronic device may maintain the Capability bit setting for the current D2D connection.

FIG. 11 is a view illustrating an example of a USD-based PIN entering skip process according to an embodiment of the disclosure.

Referring to FIG. 11, a Server may transmit a Device ID (DI) List of receiving devices to a first electronic device (Sender) (e.g., mobile device).

The first electronic device (Sender) (e.g., mobile device) may trigger a Wi-Fi Aware module for USD. A second electronic device (Receiver) (e.g., TV) may perform a Listen and/or Search operation through a Wi-Fi Direct (or P2P) module. For example, the first electronic device (Sender) (e.g., mobile device) may perform USD on one of configured channels (e.g., Ch.6, Ch.44, Ch.149). For example, the second electronic device (Receiver) (e.g., TV) may perform a Listen operation on Ch.6 and perform a Search operation on one of configured channels (e.g., Ch.1, Ch.6, Ch.11). According to an embodiment, a P2P Listen/Search channel list may be adjusted to reduce channel circulation time.

The first electronic device (Sender) (e.g., mobile device) may transmit an SDF Publish message including Miracast over Aware related information to the second electronic device (Receiver) (e.g., TV) through USD. According to an embodiment, the Miracast over Aware related information may include at least one of Radio information, D2D information, and service information.

The second electronic device (Receiver) (e.g., TV) in a P2P Listen/Search state may receive at least one of Radio information, D2D information, and service information included in the SDF Publish message.

The second electronic device (Receiver) (e.g., TV) may switch from the P2P interface to the Wi-Fi Aware interface. According to an embodiment, the second electronic device (Receiver) (e.g., TV) may execute an upper application for Miracast over Aware and trigger a Wi-Fi Aware interface. According to another embodiment, the second electronic device (Receiver) (e.g., TV) may trigger a Direct/Aware simultaneous operation mode.

The second electronic device (Receiver) (e.g., TV) may transmit an SDF subscribe message including Miracast over Aware related information to the first electronic device (Sender) (e.g., mobile device) through USD. According to an embodiment, the Miracast over Aware related information may include at least one of Radio information, D2D information, and service information. According to an embodiment, the SDF subscribe message may include SDEA, and the SDEA may include at least one of Service Info, Bitmap information including PIN Entering Skip Support, Hashed DI info, and attribute (32-bit).

The first electronic device (Sender) (e.g., mobile device) and the second electronic device (Receiver) (e.g., TV) may exchange SDF follow-up messages including authentication information and service-related detailed information. According to an embodiment, the SDF Follow-up stage may include a message exchange procedure corresponding to Provision Discovery Request/Response of P2P. According to an embodiment, the first electronic device (Sender) (e.g., mobile device) may transmit AES256-CBC-Encrypt (64-bit PIN∥48-bit MOBILE MAC∥16-bit randomly generated padding) and 128-bit VI to the second electronic device (Receiver) (e.g., TV). According to an embodiment, the second electronic device (Receiver) (e.g., TV) may transmit an encrypted PIN status (e.g., indicating Success or Failure) to the first electronic device (Sender) (e.g., mobile device).

The first electronic device (Sender) (e.g., mobile device) and the second electronic device (Receiver) (e.g., TV) may perform a NAN data path (NDP) setup procedure. The NDP setup procedure may include an authentication procedure. Thereafter, a NAN connection may be established between the first electronic device (Sender) (e.g., mobile device) and the second electronic device (Receiver) (e.g., TV).

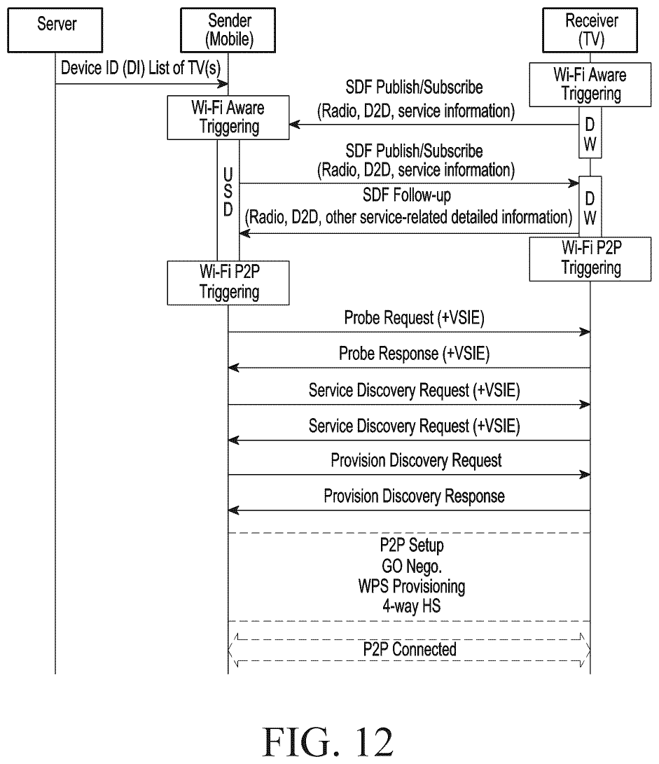

FIG. 12 is a view illustrating another example of a USD-based PIN entering skip process according to an embodiment of the disclosure.

Referring to FIG. 12, a Server may transmit a Device ID (DI) List of receiving devices to a first electronic device (Sender) (e.g., mobile device).

The first electronic device (Sender) (e.g., mobile device) may trigger a Wi-Fi Aware module for USD. A second electronic device (Receiver) (e.g., TV) may be in a state of constantly operating the Wi-Fi Aware module. For example, the first electronic device (Sender) (e.g., mobile device) may perform USD through one of preconfigured channels (e.g., Ch.6, Ch. 44, or Ch. 149). For example, the second electronic device (Receiver) (e.g., TV) may operate the DW within a configured channel (e.g., Ch.6).

The second electronic device (Receiver) (e.g., TV) may transmit an SDF Publish message (or SDF Subscribe message) including SDEA and/or VSIE to the first electronic device (Sender) (e.g., mobile device) within the Wi-Fi Aware DW. According to an embodiment, the SDEA (or the VSIE) may include at least one of Radio information, D2D information, and service information.

The first electronic device (Sender) (e.g., mobile device) may transmit an SDF Subscribe message (or SDF Publish message) including Miracast over Aware related information to the second electronic device (Receiver) (e.g., TV) through USD. According to an embodiment, the Miracast over Aware related information may include at least one of Radio information, D2D information, and service information.

The first electronic device (Sender) (e.g., mobile device) and the second electronic device (Receiver) (e.g., TV) may exchange SDF follow-up messages including authentication information. According to an embodiment, the SDF follow-up message may include at least one of Radio information, D2D information, and other service-related detailed information.

The first electronic device (Sender) (e.g., mobile device) may execute an upper service/application for Miracast over Direct and trigger Wi-Fi P2P. The second electronic device (Receiver) (e.g., TV) may execute an upper service/application for Miracast over Direct and trigger Wi-Fi P2P.

The first electronic device (Sender) (e.g., mobile device) may transmit a Probe Request message including VSIE to the second electronic device (Receiver) (e.g., TV). The second electronic device (Receiver) (e.g., TV) may transmit a Probe Response message including VSIE to the first electronic device (Sender) (e.g., mobile device).

According to an embodiment, the first electronic device (Sender) (e.g., mobile device) may transmit a Service Discovery Request message including VSIE to the second electronic device (Receiver) (e.g., TV). According to an embodiment, the second electronic device (Receiver) (e.g., TV) may transmit a Service Discovery Response message including VSIE to the first electronic device (Sender) (e.g., mobile device). According to an embodiment, when information is exchanged first in the Aware stage, some subsequent P2P procedures may be omitted, and the transmission/reception process of the Service Discovery Request message and/or Service Discovery Response message may be omitted.

The first electronic device (Sender) (e.g., mobile device) may transmit a Provision Discovery Request message including authentication information to the second electronic device (Receiver) (e.g., TV). The second electronic device (Receiver) (e.g., TV) may transmit a Provision Discovery Response message including authentication information to the first electronic device (Sender) (e.g., mobile device). According to an embodiment, when information is exchanged first in the Aware stage, some subsequent P2P procedures may be omitted, and the transmission/reception process of the Provision Discovery Request message and/or Provision Discovery Response message may be omitted.

According to an embodiment, the Provision Discovery Request message may include AES256-CBC-Encrypt (64-bit PIN∥48-bit MOBILE MAC∥16-bit randomly generated padding) and 128-bit VI. According to an embodiment, the Provision Discovery Response message may include an encrypted PIN status (e.g., indicating Success or Failure).

The first electronic device (Sender) (e.g., mobile device) and the second electronic device (Receiver) (e.g., TV) may perform a P2P setup procedure. According to an embodiment, the first electronic device (Sender) (e.g., mobile device) and the second electronic device (Receiver) (e.g., TV) may exchange GO Negotiation request messages/GO Negotiation response messages. According to an embodiment, the first electronic device (Sender) (e.g., mobile device) and the second electronic device (Receiver) (e.g., TV) may perform a Wi-Fi Protected Setup (WPS) provisioning procedure. According to an embodiment, the first electronic device (Sender) (e.g., mobile device) and the second electronic device (Receiver) (e.g., TV) may perform a 4-way handshake operation that exchanges four messages to generate an encryption key that may be used to encrypt actual data transmitted through the wireless medium. Thereafter, a P2P connection may be established between the first electronic device (Sender) (e.g., mobile device) and the second electronic device (Receiver) (e.g., TV).

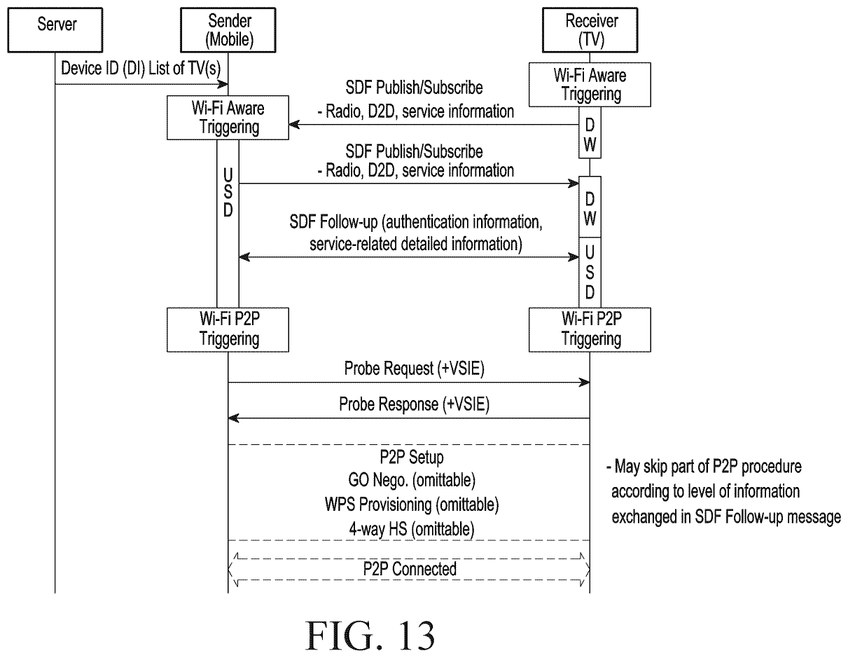

FIG. 13 is a view illustrating yet another example of a USD-based PIN entering skip process according to an embodiment of the disclosure.

Referring to FIG. 13, a Server may transmit a Device ID (DI) List of receiving devices to a first electronic device (Sender) (e.g., mobile device).

The first electronic device (Sender) (e.g., mobile device) may trigger a Wi-Fi Aware module for USD. A second electronic device (Receiver) (e.g., TV) may be in a state of constantly operating the Wi-Fi Aware module. For example, the first electronic device (Sender) (e.g., mobile device) may perform USD through one of preconfigured channels (e.g., Ch.6, Ch. 44, or Ch. 149). For example, the second electronic device (Receiver) (e.g., TV) may operate the DW within a configured channel (e.g., Ch.6).

The second electronic device (Receiver) (e.g., TV) may transmit an SDF Publish message (or SDF Subscribe message) including SDEA and/or VSIE to the first electronic device (Sender) (e.g., mobile device) within the Wi-Fi Aware DW. According to an embodiment, the SDEA (or the VSIE) may include at least one of Radio information, D2D information, and service information.

The first electronic device (Sender) (e.g., mobile device) may transmit an SDF Subscribe message (or SDF Publish message) including Miracast over Aware related information to the second electronic device (Receiver) (e.g., TV) through USD. According to an embodiment, the Miracast over Aware related information may include at least one of Radio information, D2D information, and service information.

The first electronic device (Sender) (e.g., mobile device) and the second electronic device (Receiver) (e.g., TV) may exchange SDF follow-up messages including authentication information and service-related detailed information. According to an embodiment, the SDF follow-up message may include at least one of Radio information, D2D information, and other service-related detailed information. According to an embodiment, in the SDF follow-up stage, the first electronic device (Sender) (e.g., mobile device) may transmit a Provision Discovery Request message including authentication information to the second electronic device (Receiver) (e.g., TV). According to an embodiment, in the SDF follow-up stage, the second electronic device (Receiver) (e.g., TV) may transmit a Provision Discovery Response message including authentication information to the first electronic device (Sender) (e.g., mobile device). According to an embodiment, the Provision Discovery Request message may include AES256-CBC-Encrypt (64-bit PIN∥48-bit MOBILE MAC∥16-bit randomly generated padding) and 128-bit VI. According to an embodiment, the Provision Discovery Response message may include an encrypted PIN status (e.g., indicating Success or Failure).

The first electronic device (Sender) (e.g., mobile device) may execute an upper service/application for Miracast over Direct and trigger Wi-Fi P2P. The second electronic device (Receiver) (e.g., TV) may execute an upper service/application for Miracast over Direct and trigger Wi-Fi P2P.

According to an embodiment, according to the level of information exchanged in the SDF Follow-up message, some of the P2P procedures may be omitted.

The first electronic device (Sender) (e.g., mobile device) may transmit a Probe Request message including VSIE to the second electronic device (Receiver) (e.g., TV). The second electronic device (Receiver) (e.g., TV) may transmit a Probe Response message including VSIE to the first electronic device (Sender) (e.g., mobile device).

The first electronic device (Sender) (e.g., mobile device) and the second electronic device (Receiver) (e.g., TV) may perform a P2P setup procedure. According to an embodiment, the first electronic device (Sender) (e.g., mobile device) and the second electronic device (Receiver) (e.g., TV) may exchange GO Negotiation request messages/GO Negotiation response messages. According to an embodiment, the first electronic device (Sender) (e.g., mobile device) and the second electronic device (Receiver) (e.g., TV) may perform a Wi-Fi Protected Setup (WPS) provisioning procedure. According to an embodiment, the first electronic device (Sender) (e.g., mobile device) and the second electronic device (Receiver) (e.g., TV) may perform a 4-way handshake operation that exchanges four messages to generate an encryption key that may be used to encrypt actual data transmitted through the wireless medium. Thereafter, a P2P connection may be established between the first electronic device (Sender) (e.g., mobile device) and the second electronic device (Receiver) (e.g., TV).

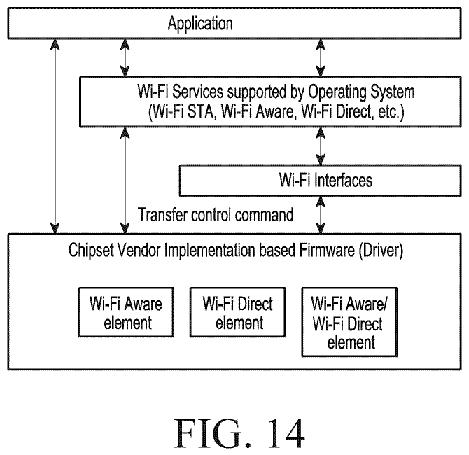

FIG. 14 is a view illustrating an architecture of an electronic device according to an embodiment of the disclosure.

Referring to FIG. 14, the architecture of the electronic device may include an application layer, a framework layer, a Wi-Fi interface layer, and a firmware layer. The framework layer may include at least one Wi-Fi Service module (e.g., at least one of Wi-Fi STA, Wi-Fi Aware, and Wi-Fi Direct) supported by an operating system (OS). The firmware layer may be chipset vendor implementation based firmware or a driver. The firmware layer may include a Wi-Fi Aware element for supporting Wi-Fi Aware communication, a Wi-Fi Direct element for supporting Wi-Fi Direct communication, and a Wi-Fi Aware/Wi-Fi Direct element for selectively and/or simultaneously supporting Wi-Fi Aware/Wi-Fi Direct communication.

According to an embodiment, control commands may be transferred between the framework layer and the firmware layer. According to an embodiment, the control commands may determine Wi-Fi P2P/Aware interface triggering and scheduling information.

According to an embodiment, the Wi-Fi P2P/Aware interface triggering and scheduling information may include at least one of an OUI field, a Length field, a Version field, a Request ID field, a Type field, a D2D trigger field, a Reserved field, a Schedule category field, and a Schedule entry field. According to an embodiment, the OUI field may indicate a Vendor specific OUI type, the Length field may indicate a length of QUI data, the Version field may indicate a firmware version, the Request ID field may indicate identification information for distinguishing requested data, the Type field may indicate a packet type, the D2D trigger field may indicate initiation or termination of a Wi-Fi P2P interface and/or Aware interface, the Schedule category field may indicate a category of the corresponding schedule ID, and the Schedule entry field may indicate schedule information for each Schedule category.

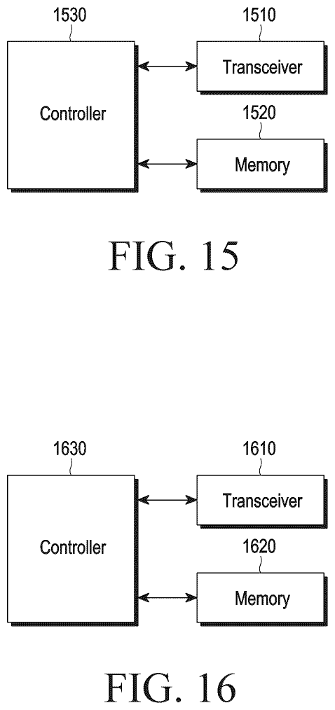

FIG. 15 is a view illustrating a structure of a first electronic device according to an embodiment of the disclosure. The first electronic device of FIG. 15 may be implemented as the first electronic device (Sender), mobile device, or electronic device described above in FIGS. 6 to 14.

Referring to FIG. 15, the first electronic device may include a transceiver 1510, memory 1520, and a controller 1530. In the disclosure, the controller may be defined as a circuit, an application specific integrated circuit, or at least one processor.

The transceiver 1510 may transmit and receive a signal to and from another electronic device. The transceiver 1510 may, e.g., transmit/receive data for mirroring.

The controller 1530 may control the overall operation of the first electronic device according to an embodiment. For example, the controller 1530 may control inter-block signal flow to perform the operations according to the above-described flowchart. Specifically, the controller 1530 may, e.g., control the operations of the first electronic device (Sender), mobile device, or electronic device described above in FIGS. 6 to 14.

The memory 1520 may store at least one of information transmitted/received via the transceiver 1510 and information generated via the controller 1530. For example, the memory 1520 may store information and data described with reference to FIGS. 1 to 14.

According to an embodiment, the controller 1530 is configured to trigger a Wi-Fi Aware interface, transmit a first message including miracast-related information through Wi-Fi Aware to a second electronic device using the Wi-Fi Aware interface, receive a second message corresponding to the first message from the second electronic device when the second electronic device triggers a Wi-Fi Aware interface based on the miracast-related information through Wi-Fi Aware, perform a mutual authentication procedure with the second electronic device, and transmit Wi-Fi Aware-based data to the second electronic device.

According to an embodiment, the miracast-related information through Wi-Fi Aware may include service information indicating miracast through Wi-Fi Aware, radio operation information of the first electronic device, and D2D information of the first electronic device.

According to an embodiment, the second electronic device is configured to process the first message at a Wi-Fi Direct interface.

According to an embodiment, the first message may be a service discovery frame (SDF) Publish message, and the second message may be an SDF Subscribe message.

According to an embodiment, the miracast-related information through Wi-Fi Aware may be included in a service descriptor extension attribute (SDEA) field or a vendor specific IE (VSIE) field.

According to an embodiment, the service information may include an organizational unique identifier (OUI) field, a service protocol type field, and a service specific info field.

FIG. 16 is a view illustrating a structure of a second electronic device according to an embodiment of the disclosure. The second electronic device of FIG. 16 may be implemented as the second electronic device (Receiver), display device (e.g., TV), or electronic device described above in FIGS. 6 to 14.

Referring to FIG. 16, the second electronic device may include a transceiver 1610, memory 1620, and a controller 1630. In the disclosure, the controller may be defined as a circuit, an application specific integrated circuit, or at least one processor.

The transceiver 1610 may transmit and receive a signal to and from another electronic device. The transceiver 1610 may, e.g., transmit/receive data for mirroring.

The controller 1630 may control the overall operation of the second electronic device according to an embodiment. For example, the controller 1620 may control inter-block signal flow to perform the operations according to the above-described flowchart. Specifically, the controller 1620 may, e.g., control the operations of the second electronic device (Receiver), display device (e.g., TV), or electronic device described above in FIGS. 6 to 14.

The memory 1620 may store at least one of information transmitted/received via the transceiver 1610 and information generated via the controller 1620. For example, the memory 1620 may store information and data necessary for mirroring described above with reference to FIGS. 1 to 14.

According to an embodiment, the controller 1620 is configured to receive a first message including miracast-related information through Wi-Fi Aware from a first electronic device using a Wi-Fi Direct interface, perform switching from the Wi-Fi Direct interface to a Wi-Fi Aware interface based on the miracast-related information through Wi-Fi Aware, transmit a second message corresponding to the first message to the first electronic device using the Wi-Fi Aware interface, perform a mutual authentication procedure with the first electronic device, and receive Wi-Fi Aware-based data from the first electronic device.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first electronic device in a wireless communication system, the method comprising:
triggering a wireless fidelity aware (Wi-Fi Aware) interface;
transmitting a first message including miracast-related information through Wi-Fi Aware to a second electronic device using the Wi-Fi Aware interface;
receiving a second message corresponding to the first message from the second electronic device based on the second electronic device triggering a Wi-Fi Aware interface using the miracast-related information through Wi-Fi Aware;
performing a mutual authentication procedure with the second electronic device; and
transmitting Wi-Fi Aware-based data to the second electronic device.

2. The method of claim 1, wherein the miracast-related information through Wi-Fi Aware includes service information indicating miracast through Wi-Fi Aware, radio operation information of the first electronic device, and device-to-device (D2D) information of the first electronic device.

3. The method of claim 1, wherein the second electronic device is configured to process the first message at a wireless fidelity direct (Wi-Fi Direct) interface.

4. The method of claim 1, wherein the first message is a service discovery frame (SDF) Publish message, and the second message is an SDF Subscribe message.

5. The method of claim 1, wherein the miracast-related information through Wi-Fi Aware is included in a service descriptor extension attribute (SDEA) field or a vendor specific information element (IE) (VSIE) field.

6. The method of claim 2, wherein the service information includes an organizational unique identifier (OUI) field, a service protocol type field, and a service specific info field.

7. The method of claim 6, wherein when the service protocol type field is set to one of 4 to 255, miracast through Wi-Fi Aware is indicated, or when the service protocol type field is set to 2, miracast through Wi-Fi Aware is indicated.

8. A method performed by a second electronic device in a wireless communication system, the method comprising:
receiving a first message including miracast-related information through wireless fidelity aware (Wi-Fi Aware) from a first electronic device using a wireless fidelity direct (Wi-Fi Direct) interface;
performing switching from the Wi-Fi Direct interface to a Wi-Fi Aware interface based on the miracast-related information through Wi-Fi Aware;
transmitting a second message corresponding to the first message to the first electronic device using the Wi-Fi Aware interface;
performing a mutual authentication procedure with the first electronic device; and
receiving Wi-Fi Aware-based data from the first electronic device.

9. The method of claim 8, wherein the miracast-related information through Wi-Fi Aware includes service information indicating miracast through Wi-Fi Aware, radio operation information of the first electronic device, and device-to-device (D2D) information of the first electronic device.

10. The method of claim 8, wherein the first message is a service discovery frame (SDF) Publish message, and the second message is an SDF Subscribe message.

11. The method of claim 8, wherein the miracast-related information through Wi-Fi Aware is included in a service descriptor extension attribute (SDEA) field or a vendor specific information element (IE) (VSIE) field.

12. The method of claim 9, wherein the service information includes an organizational unique identifier (OUI) field, a service protocol type field, and a service specific info field.

13. A first electronic device in a wireless communication system, the first electronic device comprising:
a transceiver;
memory storing instructions; and
one or more processors communicatively coupled to the transceiver and the memory,
wherein the instructions, when executed by the one or more processors individually or collectively, cause the first electronic device to:
trigger a wireless fidelity aware (Wi-Fi Aware) interface,
transmit a first message including miracast-related information through Wi-Fi Aware to a second electronic device using the Wi-Fi Aware interface,
receive a second message corresponding to the first message from the second electronic device based on the second electronic device triggering a Wi-Fi Aware interface using the miracast-related information through Wi-Fi Aware,
perform a mutual authentication procedure with the second electronic device, and
transmit Wi-Fi Aware-based data to the second electronic device.

14. The first electronic device of claim 13, wherein the miracast-related information through Wi-Fi Aware includes service information indicating miracast through Wi-Fi Aware, radio operation information of the first electronic device, and device-to-device (D2D) information of the first electronic device.

15. The first electronic device of claim 13, wherein the second electronic device is configured to process the first message at a wireless fidelity direct (Wi-Fi Direct) interface.

16. The first electronic device of claim 13, wherein the first message is a service discovery frame (SDF) Publish message, and the second message is an SDF Subscribe message.

17. The first electronic device of claim 13, wherein the miracast-related information through Wi-Fi Aware is included in a service descriptor extension attribute (SDEA) field or a vendor specific information element (IE) (VSIE) field.

18. The first electronic device of claim 14, wherein the service information includes an organizational unique identifier (OUI) field, a service protocol type field, and a service specific info field.

19. A second electronic device in a wireless communication system, the second electronic device comprising:
a transceiver;
memory storing instructions; and
one or more processors communicatively coupled to the transceiver and the memory,
wherein instructions, when executed by the one or more processors individually or collectively, cause the second electronic device to:
receive a first message including miracast-related information through wireless fidelity aware (Wi-Fi Aware) from a first electronic device using a wireless fidelity direct (Wi-Fi Direct) interface,
perform switching from the Wi-Fi Direct interface to a Wi-Fi Aware interface based on the miracast-related information through Wi-Fi Aware,
transmit a second message corresponding to the first message to the first electronic device using the Wi-Fi Aware interface,
perform a mutual authentication procedure with the first electronic device, and
receive Wi-Fi Aware-based data from the first electronic device.

20. The second electronic device of claim 19, wherein the miracast-related information through Wi-Fi Aware includes service information indicating miracast through Wi-Fi Aware, radio operation information of the first electronic device, and device-to-device (D2D) information of the first electronic device.
